(19) United States
(12) Patent Application Publication
(10) Pub. No.: US 2011/0229785 A1
(43) Pub. Date: Sep. 22, 2011

(54) FUEL CELL STACK AND FUEL CELL SYSTEM HAVING THE SAME

(76) Inventors: Kah-Young Song, Yongin-si (KR); Hee-Tak Kim, Yongin-si (KR); Sang-Il Han, Yongin-si (KR); Tae-Yoon Kim, Yongin-si (KR); Sung-Yong Cho, Yongin-si (KR); Myoung-Ki Min, Yongin-si (KR); Geun-Seok Chai, Yongin-si (KR)

(21) Appl. No.: 12/796,456

(22) Filed: Jun. 8, 2010

Related U.S. Application Data
(60) Provisional application No. 61/314,895, filed on Mar. 17, 2010.

(51) Int. Cl. H01M 8/24

(52) U.S. Cl. 429/452

(57) ABSTRACT

A fuel cell stack includes a plurality of membrane electrode assemblies, each of the membrane electrode assemblies having an electrolyte membrane; an anode on a first side of the electrolyte membrane; and a cathode on a second side of the electrolyte membrane opposite to the first side, wherein the anode and the cathode each comprise a gas diffusion layer divided into at least two areas such that a first area and a second area have different area densities; and a separator between adjacent membrane electrode assemblies.

### CROSS-REFERENCE TO RELATED APPLICATIONS

This application claims the benefit of U.S. Provisional Application No. 61/314,895, filed on Mar. 17, 2010, in the United States Patent and Trademark Office, the disclosure of which is incorporated herein in its entirety by reference.

### BACKGROUND

1. Field

The present invention relates to a fuel cell system.

2. Description of the Related Art

A fuel cell system includes a fuel cell stack generating electrical energy using electrochemical reaction of a fuel (hydrocarbon-based fuel, hydrogen, or rich hydrogen gas) and an oxidizing agent (air or oxygen), a fuel supply supplying a fuel to the fuel cell stack, and an oxidizing agent supply supplying an oxidizing agent to the fuel cell stack. The fuel cell stack includes a plurality of membrane electrode assemblies (MEAs) and a separator (also referred to as a bipolar plate) located between the MEAs.

Each MEA includes an electrolyte membrane, an anode formed at one side of the electrolyte membrane, and a cathode formed at the other side of the electrolyte membrane. The separator forms a fuel channel at one side facing the anode to supply a fuel to the anode therethrough, and forms an oxidizing agent channel at one side facing the cathode to supply the oxidizing agent to the cathode therethrough. Then, a hydrogen oxidation reaction in the anode and an oxygen reduction reaction in the cathode generate electrical energy, and heat and moisture are additionally generated.

During operation of the fuel cell stack, water is additionally generated in a specific area rather than being generated over the entire area of the MEA, and the amount of water is increased as the current density is increased. Thus, dispersion of an oxidizing agent is deteriorated in an area where a large amount of water is generated, and the MEA is deteriorated or electrochemical reaction does not occur in an area lacking water. Accordingly, uniform reaction cannot be induced over the entire area of the MEA, thereby causing performance deterioration of the fuel cell stack.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a fuel cell stack that can increase electrical energy generation efficiency by inducing a generally uniform electrochemical reaction in substantially the entire area of a membrane electrode assembly (MEA), and a fuel cell system incorporating the fuel cell stack.

A fuel cell stack according to an exemplary embodiment of the present invention includes a plurality of membrane electrode assemblies, each of the membrane electrode assemblies having an electrolyte membrane; an anode on a first side of the electrolyte membrane; and a cathode on a second side of the electrolyte membrane opposite to the first side, wherein the anode and the cathode each comprise a gas diffusion layer divided into at least two areas such that a first area and a second area have different area densities; and a separator between adjacent membrane electrode assemblies.

In one embodiment, the gas diffusion layer includes a backing layer made of a thin porous material such as carbon paper, carbon cloth, carbon felt, metal or metal matt and a micro-porous layer made of carbon powder, carbon nano-rods, carbon nanowires, carbon nanotubes, a conductive metal, an inorganic material or a ceramic powder.

In one embodiment, the backing layer in the first area has an area density between about 50 g/m² and about 300 g/m² and the backing layer in the second area has an area density between about 10 g/m² and about 50 g/m² and the micro-porous layer in the first area has an area density between about 30 g/m² and about 100 g/m² and the backing layer in the second area has an area density of about or less than 70 g/m².

The gas diffusion layer may be coated with a hydrophobic material or a hydrophilic material, such as polytetrafluoroethylene or a sulfonated tetrafluoroethylene copolymer.

Further, the separator may have an oxidizing agent inlet and an oxidizing agent outlet, wherein the first area is proximate to the oxidizing agent inlet and has a higher area density than the second area, and the separator may have a fuel inlet and a fuel outlet, wherein the first area is proximate to the fuel inlet and has a higher area density than the second area.

In another embodiment, a fuel cell stack is provided including a plurality of membrane electrode assemblies, each of the membrane electrode assemblies including an electrolyte membrane; an anode on a first side of the electrolyte membrane; and a cathode on a second side of the electrolyte membrane opposite to the first side, wherein the anode and the cathode each comprise a gas diffusion layer, wherein an area density of the gas diffusion layer gradually changes over the gas diffusion layer; and a separator between adjacent ones of the membrane electrode assemblies.

In one embodiment, the separator has an oxidizing agent inlet and an oxidizing agent outlet and wherein the area density of the gas diffusion layer of the cathode gradually decreases in a general direction from the oxidizing agent inlet to the oxidizing agent outlet and the separator has a fuel inlet and a fuel outlet and wherein the area density of the gas diffusion layer of the anode gradually decreases in a general direction from the fuel inlet to the fuel outlet.

### BRIEF DESCRIPTION OF THE DRAWINGS

FIG. 1 is a partially exploded perspective view of a fuel cell stack according to a first exemplary embodiment of the present invention.

FIG. 2 is an exploded perspective view of one MEA and two separators of the fuel cell stack of FIG. 1.

FIG. 3 is a partial cross-sectional view of the MEA and the separators of FIG. 2.

FIG. 4 is a schematic diagram of a gas diffusion layer of the cathode of the fuel cell stack of FIG. 3.

FIG. 5 is a schematic diagram of a gas diffusion layer of the anode of the fuel cell stack of FIG. 3.

FIG. 6 is a schematic diagram of a gas diffusion layer of a cathode of a fuel cell stack according to a second exemplary embodiment of the present invention.

FIG. 7 is a schematic diagram of a gas diffusion layer of an anode of the fuel cell stack according to the second exemplary embodiment of the present invention.

FIG. 8 is a schematic diagram of a gas diffusion layer of a cathode of a fuel cell stack according to a third exemplary embodiment of the present invention.

FIG. 9 is a schematic diagram of a gas diffusion layer of an anode of the fuel cell stack according to the third exemplary embodiment of the present invention.

FIG. 10 is a schematic diagram of a gas diffusion layer of a cathode of a fuel cell stack according to a fourth exemplary embodiment of the present invention.

FIG. 11 is a schematic diagram of a diffusion gas layer of an anode of the fuel cell stack according to the fourth exemplary embodiment of the present invention.

FIG. 12 is a graph of results of the power density experiments of the MEAs of the exemplary embodiment and the comparative exemplary embodiment.

FIG. 13 is a schematic diagram of the entire configuration of the fuel cell system according to an exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

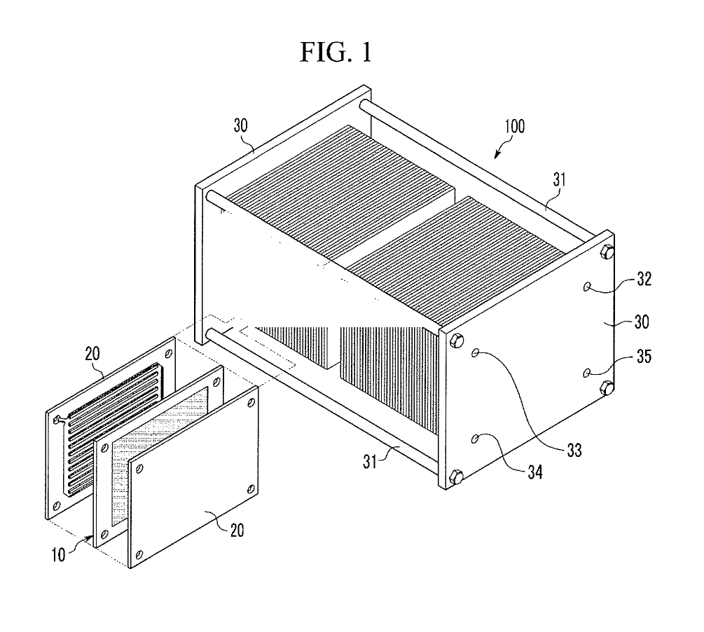

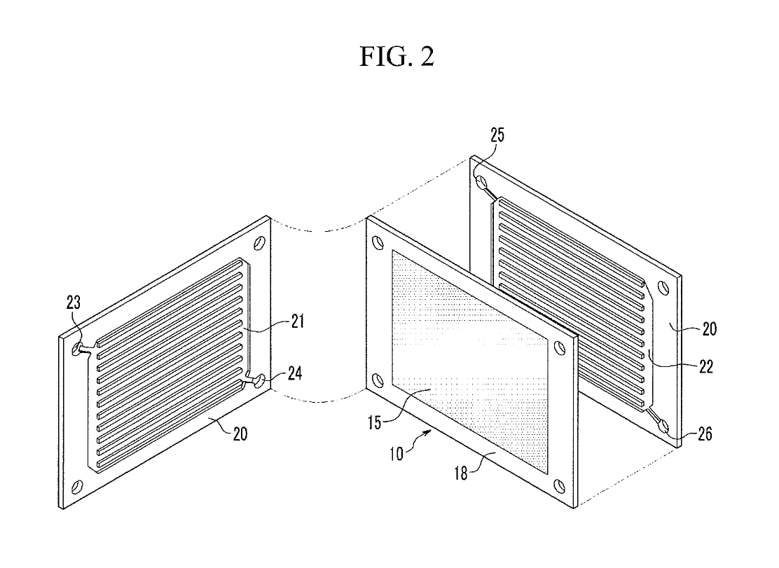

FIG. 1 is a perspective view of a fuel cell stack according to a first exemplary embodiment of the present invention, and FIG. 2 is an exploded perspective view of one MEA and two separators of the fuel cell stack of FIG. 1.

Referring to FIG. 1 and FIG. 2, a fuel cell stack 100 according to the first exemplary embodiment includes a plurality of membrane electrode assemblies (MEAs) 10 and a plurality of separators 20 located adjacent to the MEAs 10 between the MEAs 10. One MEA 10 and the two separators 20 located sides of the MEA 10 form one electric generation unit (i.e., unit cell) generating electrical energy.

The separator 20, also called a bipolar plate, and a pair of end plates 30 are located at the outer edge of the fuel cell stack 100. The fuel cell stack 100 is firmly assembled by a fastening means such as a bolt 31 penetrating the two end plates 30. A fuel inlet 32 supplying a fuel, an oxidizing agent inlet 33 supplying an oxidizing agent, a fuel outlet 34 emitting an unreacted fuel, and an oxidizing agent outlet 35 emitting moisture and unreacted air are provided in one of the end plates 30.

FIG. 1 illustrates two inlets 32 and 33 and two outlets 34 and 35 in one end plate 30, but the fuel inlet 32 and the oxidizing agent inlet 33 may be formed in one end plate 30 and the fuel outlet 34 and the oxidizing agent outlet 35 may be formed in the other end plate 30.

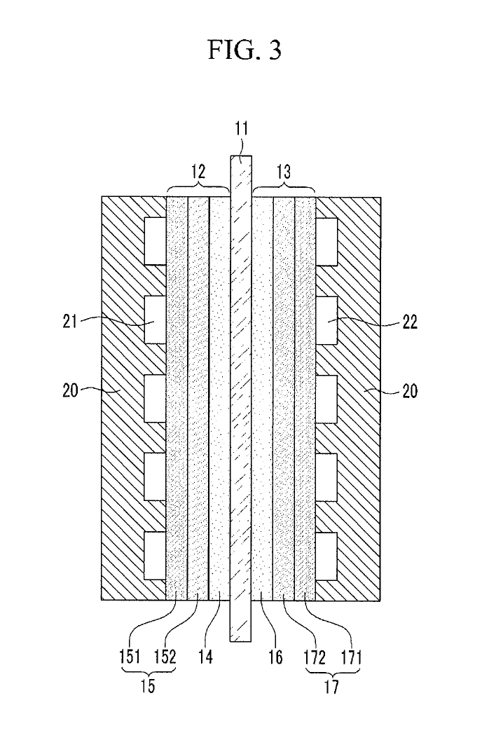

FIG. 3 is a partial cross-sectional view of the MEA and separators of FIG. 2.

Referring to FIG. 3, the MEA 10 includes an electrolyte membrane 11, a cathode 12 formed at one side of the electrolyte membrane 11, and an anode 13 formed at the other side of the electrolyte membrane 11.

The cathode 12 is supplied with the oxidizing agent, and includes a catalyst layer 14 transforming oxygen on the oxidizing agent into electrons and oxygen ions by a reduction reaction, and a gas diffusion layer 15 contacting the external surface of the catalyst layer 14 and smoothing movement of the electrons and oxygen ions. The anode 13 is supplied with the fuel, and includes a catalyst layer 16 transforming hydrogen in the fuel to electrons and hydrogen ions by an oxidation reaction, and a gas diffusion layer 17 contacting the external surface of the catalyst layer 16 and smoothing movement of the electrons and hydrogen ions.

The electrolyte membrane 11 may be a solid polymer electrolyte having a thickness of about 5 μm to about 200 μm, and the anode 13 has an ion exchange function for moving the hydrogen ions generated in the catalyst layer 16 to the catalyst layer 14 of the cathode 12. In FIG. 2, reference numeral 18 represents a supporting sheet that supports the MEA 10.

The separator 20 functions as a conductor that connects the cathode 12 of the MEA at one side and the anode 13 of the MEA 10 at the other side in series. In addition, the separator 20 forms an oxidizing agent channel 21 at a side facing the cathode 12 to supply the oxidizing agent to the cathode 12 therethrough, and forms a fuel channel 22 at a side facing the anode 13 to supply the fuel to the anode 13 therethrough.

Referring to FIG. 2 and FIG. 3, an oxidizing agent inlet manifold 23 and an oxidizing agent outlet manifold 24 are formed at corners of the separator 20 and are connected with the oxidizing agent channel 21. The oxidizing agent channel 21 has a concave groove connecting the oxidizing agent inlet manifold 23 and the oxidizing agent outlet manifold 24. At the other corners of the separator 20, a fuel inlet manifold 25 and a fuel outlet manifold 26 connected with the fuel channel 22 are formed. The fuel channel 22 has a concave groove connecting the fuel inlet manifold 25 and the fuel outlet manifold 26.

The oxidizing agent supplied through the oxidizing agent inlet 33 is dispersed to the oxidizing agent channels 21 of the respective separators 20 through the oxidizing agent inlet manifold 23 connected with the oxidizing agent inlet 33. Thus, the oxidizing agents are simultaneously supplied to the cathodes 12 of the MEAs 10. In addition, moisture and unreacted air passing through the oxidizing agent outlet manifold 24 in the opposite side are emitted through the oxidizing agent outlet 35.

The fuel supplied through the fuel inlet 32 is dispersed to the fuel channels 22 of the respective separators 20 through the fuel inlet manifold 25 connected with the fuel inlet 32. Thus, the fuel is simultaneously supplied to the anodes 13 of the respective MEAs 10. In addition, unreacted fuel passing through the fuel outlet manifold 26 at the opposite side is emitted through the fuel outlet 34.

When the fuel cell stack 100 with the above configuration generates electrical energy, water and heat are additionally generated. However, the water is generated in a specific area rather than being uniformly generated over the entire areas of the MEA 10, and therefore moisture dispersion in the MEA 10 becomes non-uniform. The non-uniform moisture dispersion causes deterioration of the fuel cell stack 100 and electrical energy generation efficiency.

In the fuel cell stack 100 of the present exemplary embodiment, the gas diffusion layers 15 and 17 are divided into at least two areas, and each has a different area density in the at least two divided areas. The gas diffusion layers 15 and 17 minimize moisture loss in an area where moisture lacks and smooth moisture emission in a moisture-rich area to provide uniform moisture dispersion in the MEA 10.

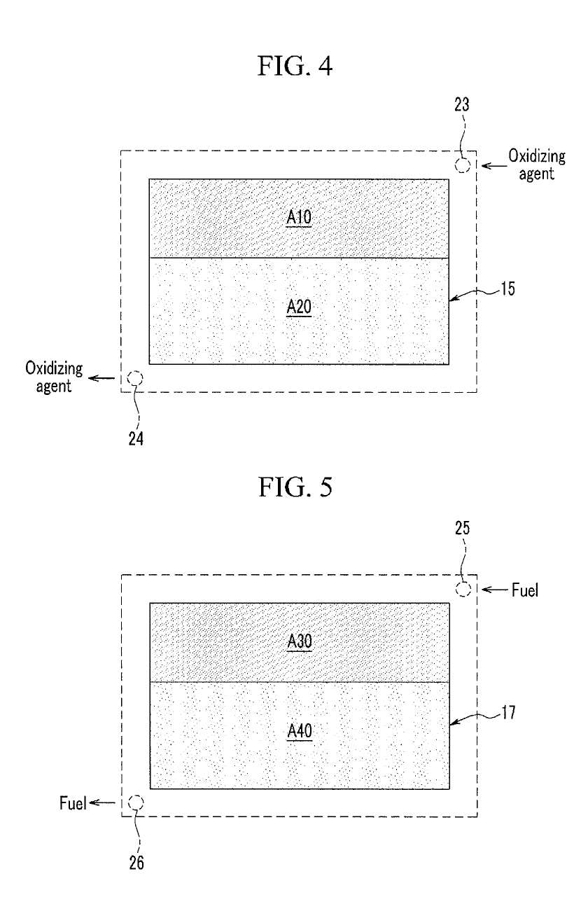

FIG. 4 shows a schematic diagram of the gas diffusion layer of the cathode of the fuel cell stack, and FIG. 5 shows a schematic diagram of the gas diffusion layer of the anode of the fuel cell stack of FIG. 3.

Referring to FIG. 3 to FIG. 5, the gas diffusion layer 15 of the cathode 12 is divided into a first area A10 neighboring the oxidizing agent inlet manifold 23 and a second area A20 neighboring the oxidizing agent outlet manifold 24. In addition, the area density of the gas diffusion layer 15 measured in the first area A10 is higher than that of the gas diffusion layer 15 measured in the second area A20.

The gas diffusion layer 17 of the anode 13 is divided into a third area A30 neighboring the fuel inlet manifold 25 and a fourth area A40 neighboring the fuel outlet manifold 26. In addition, the area density of the gas diffusion layer 7 measured in the third area A30 is higher than that of the gas diffusion layer 71 measured in the fourth area A40.

However, the locations of the oxidizing agent inlet manifold 23 and the oxidizing agent outlet manifold 24 are not limited to the locations shown in FIG. 4. The first area A10 of the gas diffusion layer 15 is defined to be an area neighboring the oxidizing agent inlet manifold 23 without regard to the location of the oxidizing agent inlet manifold 23. The locations of the fuel inlet manifold 25 and the fuel outlet manifold 26 are not limited to the locations shown in FIG. 5. The third area A30 of the gas diffusion layer 17 is defined to be an area neighboring the fuel inlet manifold 25 without regard to the location of the fuel inlet manifold 25.

The gas diffusion layers 15 and 17 may be effectively applied to the fuel cell stack 100 being rich in moisture at the peripheries of the oxidizing agent outlet manifold 24 and the fuel outlet manifold 26 and lacking moisture at the peripheries of the oxidizing agent inlet manifold 23 and the fuel inlet manifold 25 in the MEA 10 when the fuel cell stack 100 is driven.

The gas diffusion layers 15 and 17 are formed of layered structures of backing layers 151 and 171 and micro-porous layers 152 and 172 contacting one side of the backing layers 151 and 171. The backing layers 151 and 171 are formed of a porous thin plate material such as a carbon paper, a carbon cloth, a carbon felt, a porous metal plate, and a porous metal matt, or are formed by layering two or more of the porous thin plate materials. The micro-porous layers 152 and 172 include at least one of carbon powder, carbon nano-rods, carbon nanowires, carbon nanotubes, a conductive metal, an inorganic material, and a ceramic powder.

A hydrophobic material such as polytetrafluoroethylene or a hydrophilic material such as a sulfonated tetrafluoroethylene copolymer (e.g., NAFION® ionomer) may be used for the surface treatment of the backing layers 151 and 171 and the micro-porous layers 152 and 172. The hydrophobic surface treatment can prevent flooding in the gas diffusion layers 15 and 17, and the hydrophilic surface treatment can increase moisture content in the MEA 10.

The gas diffusion layers 15 and 17 may be divided into the first area A10, the second area A20, the third area A30, and the fourth area A40 by controlling the area density of the backing layers 151 and 171 or the area density of the micro-porous layers 152 and 172, or by controlling the area density of the backing layers 151 and 171 and the micro-porous layers 152 and 172 together. The backing layers 151 and 171 and the micro-porous layers 152 and 172 have pores, and the water permeability of the backing layers 151 and 171 and the micro-porous layers 151 and 172 is changed in accordance with the area density, respectively.

The gas diffusion layers 15 and 17 decrease the water permeability of the first and third areas A10 and A30 where moisture lacks with the high area density, and increases the water permeability in the second and fourth areas A20 and A40 where moisture is rich with the low area density. Therefore, the gas diffusion layers 15 and 17 lock the moisture in the first and third areas A10 and A30 to minimize moisture loss, and increase the emission of the moisture in the second and fourth areas A20 and A40.

In further detail, the gas diffusion layer 15 of the cathode 12 transmits moisture generated in the catalyst layer 14 to the electrolyte membrane 11 and the oxidizing agent channel 21 of the separator 20. In the first area A10, the gas diffusing layer 15 decreases the movement of the moisture towards the oxidizing agent channel 21 with the high area density, therefore the moisture mainly moves to the electrolyte membrane 11. In the second area A20, the gas diffusing layer 15 increases the movement of the moisture towards the oxidizing agent channel 21 with the low area density, therefore the emission of the moisture can increase and flooding can be prevented.

In addition, the gas diffusion layer 17 of the anode 13 transmits the moisture generated in the catalyst layer 16 to the fuel channel 22 of the separator 20. In the third area A30, the gas diffusing layer 17 decreases the movement of the moisture towards the fuel channel 22 with the high area density, therefore the moisture primarily moves to the electrolyte membrane 11. In the fourth area A40, the gas diffusing layer 17 increases the movement of the moisture towards the fuel channel 22 with the low area density, therefore the emission of the moisture can increase and flooding can be prevented.

Thus, the moisture dispersion of the MEA 10 can be substantially uniform in the entire area by the gas diffusion layers 15 and 17. Accordingly, the oxidizing agent can be substantially uniformly dispersed over the entire area of the cathode 12, deterioration of the MEA 10 due to moisture lack can be substantially prevented, and electrical energy production efficiency can be increased by inducing uniform electrochemical reaction over the entire area of the MEA 10.

The backing layers 151 and 171 of the gas diffusion layers 15 and 17 may have the area density of about 50 g/m² to about 300 g/m² in the first and the third areas A10 and A30, and about 10 g/m² to about 50 g/m² in the second and the fourth areas A20 and A40. The micro-porous layers 152 and 72 of the gas diffusion layers 15 and 17 may have the area density of about 30 g/m² to about 100 g/m² in the first and the third areas A10 and A30, and about 70 g/m² or less in the second and the fourth areas A20 and A40.

In this exemplary embodiment, the gas diffusion layers 15 and 17 of the cathode 12 and the anode 13 are both divided into two areas. However, in one embodiment, only one of the gas diffusion layers 15 and 17 of the cathode 12 and the anode 13 may be divided into two areas.

In FIG. 4 and FIG. 5, the second area A20 is larger than the first area A10 and the fourth area A40 is larger than the area A30, but the areas of the gas diffusion layers 15 and 17 may be variously modified. That is, the first and second areas A10 and A20 may be configured to be the same size or different size, and the third and fourth areas A30 and A40 may be configured to be the same size or different size.

In addition, in FIG. 4 and FIG. 5, the gas diffusion layers 15 and 17 are respectively divided into two areas, but at least one additional area may be located between the first and second areas A10 and A20 and between the third and fourth areas A30 and A40. The area density measured in the additional areas of the gas diffusion layers 15 and 17 is higher than the area density measured in the second and fourth areas A20 and A40 of the gas diffusion layers 15 and 17, and is lower than the area density measured in the first and third areas A10 and A30 of the gas diffusion layers 15 and 17.

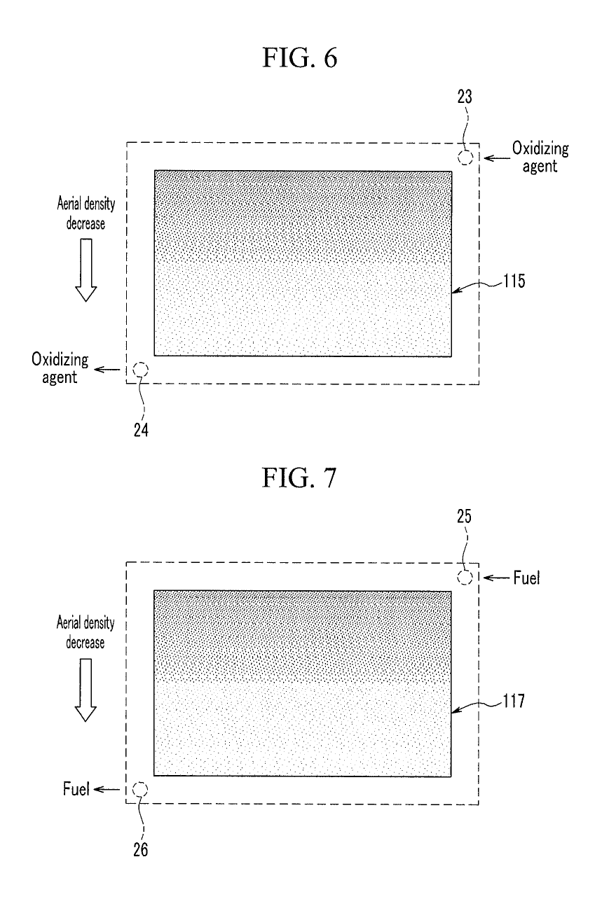

FIG. 6 shows a schematic diagram of a gas diffusion layer of a cathode of a fuel cell stack according to a second exemplary embodiment of the present invention, and FIG. 7 shows a schematic diagram of a gas diffusion layer of an anode of the fuel cell stack according to the second exemplary embodiment of the present invention.

Referring to FIG. 6 and FIG. 7, a gas diffusion layer 115 of a cathode 12 has area density that is gradually decreased along at least one direction toward an oxidizing agent outlet manifold 24 from an oxidizing agent inlet manifold 23. A gas diffusion layer 117 of an anode 13 has area density that is gradually decreased along at least one direction toward a fuel outlet manifold 26 from a fuel inlet manifold 25.

The gas diffusion layers 115 and 117 may respectively have a rectangular shape having a pair of long sides and a pair of short sides, and the area density of the gas diffusion layers 115 and 117 may be gradually changed along one of a direction parallel with the long side, a direction parallel with the short side, and a diagonal direction. FIG. 6 and FIG. 7 illustrate that the area density of the gas diffusion layers 115 and 117 changes along the direction parallel with the short side, but is not limited as such.

The area density variation of the gas diffusion layers 115 and 117 may be configured by controlling the area density of backing layers 151 and 171 or the area density of micro-porous layers 152 and 172, or by controlling the area density of both the backing layers 151 and 171 and the micro-porous layers 152 and 172. In the fuel cell stack according to the second exemplary embodiment, the area density is controlled by subdividing the gas diffusion layers 115 and 117 and, accordingly, moisture dispersion in the entire area of an MEA 10 can be further substantially uniform.

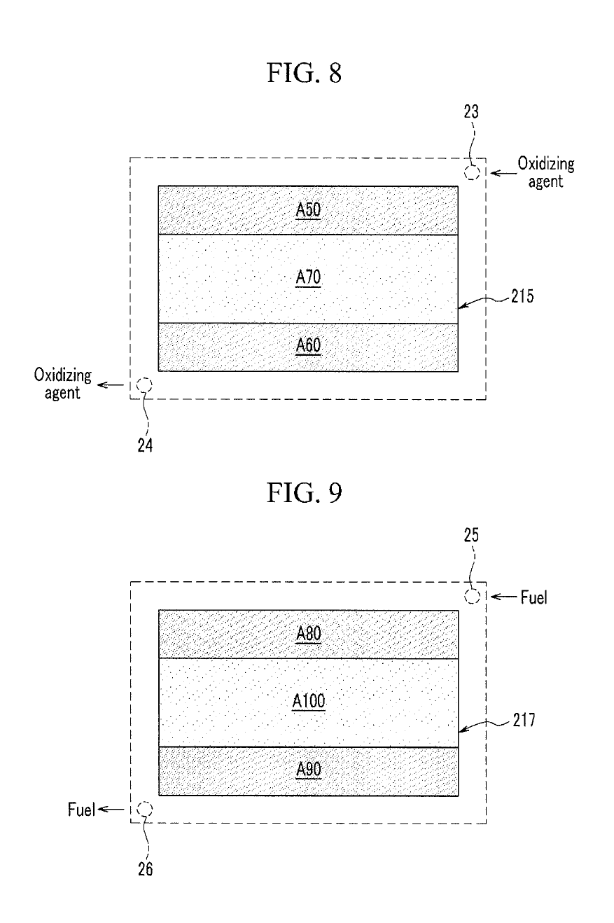

FIG. 8 shows a schematic diagram of a cathode of a fuel cell stack according to a third exemplary embodiment of the present invention, and FIG. 9 shows a schematic diagram of a gas diffusion layer of an anode of a fuel cell stack according to a third exemplary embodiment of the present invention.

Referring to FIG. 8 and FIG. 9, a gas diffusion layer 215 of a cathode 12 is divided into a fifth area A50 neighboring an oxidizing agent inlet manifold 23, a sixth area A60 neighboring an oxidizing agent outlet manifold 24, and a seventh area A70 located between the fifth and sixth areas A50 and A60. In addition, the area density of the gas diffusion layer 215 measured in the fifth and sixth areas A50 and A60 is higher than that of the gas diffusion layer 215 measured in the seventh area A70. The area density of the gas diffusion layer 215 measured in the fifth area A50 may be the same as that of the gas diffusion layer 215 measured in the sixth area A60.

A gas diffusion layer 217 of an anode 13 is divided into an eighth area A80 neighboring a fuel inlet manifold 25, a ninth area A90 neighboring a fuel outlet manifold 26, and a tenth area A100 located between the eighth and ninth areas A80 and A90. In addition, the area density of the gas diffusion layer 217 measured in the eighth area A80 and the ninth area A90 is higher than that of the gas diffusion layer 217 measured in the tenth area A100. The area density of the gas diffusion layer 217 measured in the eighth area A80 may be the same as that of the gas diffusion layer 217 measured in the ninth area A90.

The gas diffusion layers 215 and 217 may be effectively applied to a fuel cell stack being rich in moisture at the center area of the MEA 10 and lacking moisture at the peripheries of the oxidizing agent inlet manifold 23, the oxidizing agent outlet manifold 24, the fuel inlet manifold 25, and the fuel outlet manifold 26 when the fuel cell stack is operated.

The area density variation of the gas diffusion layers 215 and 217 may be configured by controlling the area density of backing layers 151 and 171 or controlling the area density of micro-porous layers 152 and 172, or by controlling the area density of the backing layers 151 and 171 and the micro-porous layers 152 and 172 together.

The gas diffusion layers 215 and 217 minimize moisture loss by locking moisture in the relatively dry fifth, sixth, eight, and ninth areas A50, A60, A80, and A90, and increase the emitting moisture in the seventh and tenth areas A70 and A100 where a large amount of moisture is generated. Thus, the gas diffusion layers 215 and 217 can provide uniform moisture dispersion over the entire area of the MEA 10.

The fifth area A50 to the tenth area A100 may vary in size rather than being limited to the size shown in FIG. 8 and FIG. 9. In addition, at least one additional area may be located between the fifth and seventh areas A50 and A70, between the sixth and seventh areas A60 and A70, between the eight and tenth areas A80 and A100, and between the ninth and tenth areas A90 and A100. The area density of the gas diffusion layers 215 and 217 may be a middle value between two aerial densities respectively measured in two neighboring areas.

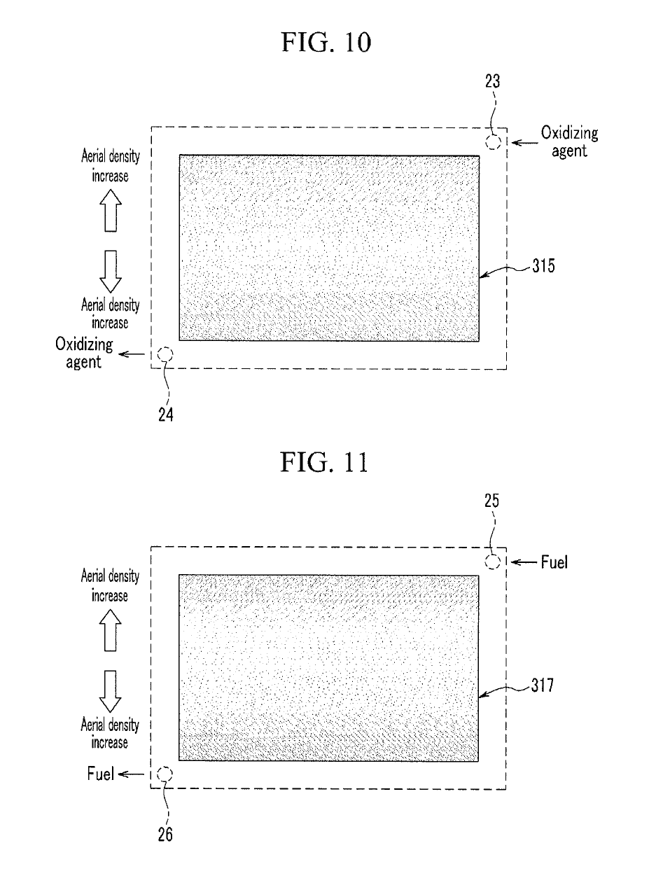

FIG. 10 shows a schematic diagram of a gas diffusion layer of a cathode of a fuel cell stack according to a fourth exemplary embodiment of the present invention, and FIG. 11 shows a schematic diagram of a gas diffusion layer of an anode of the fuel cell stack according the fourth exemplary embodiment of the present invention.

Referring to FIG. 10 and FIG. 11, a gas diffusion layer 315 of a cathode 12 has area density that is gradually decreased along at least one direction toward an oxidizing agent outlet manifold 24 from an oxidizing agent inlet manifold 23 and then is gradually increased. A gas diffusion layer 317 of an anode 13 has area density that is gradually decreased along at least one direction toward a fuel outlet manifold 26 from a fuel inlet manifold 25 and then is gradually increased.

The area density of the gas diffusion layers 315 and 317 may be gradually changed along one of a direction parallel with a long side, a direction parallel with a short direction, and a diagonal direction. In FIG. 10 and FIG. 11, the area density of the gas diffusion layers 315 and 317 are changed along the direction parallel with the short side, but is not limited thereto.

In the second exemplary embodiment to the fourth exemplary embodiment, one of the gas diffusion layers 15 and 17 of the cathode 12 and the anode 13 may be formed to have uniform area density without a division of areas and a gradual change of the area density. That is, the division of areas and the gradual change of the area density may be applied to one of the gas diffusion layers 15 and 17 of the cathode 12 and the anode 13.

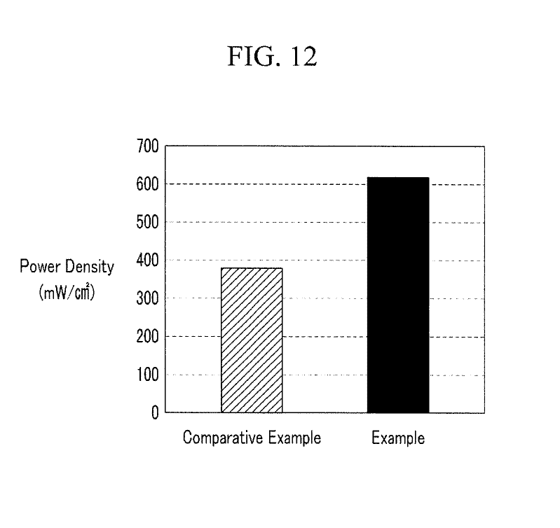

FIG. 12 shows a graph of the results of the power density experiments of the MEAs of an exemplary embodiment and a comparative exemplary embodiment.

In the MEA of the exemplary embodiment, the gas diffusion layer 12 of the cathode is divided into the first area A10 and the second area A20 (refer to FIG. 4), and the first and the second areas A10 and A20 have the area density of about 174 g/m², respectively. In the fuel cell stack of the comparative exemplary embodiment, a gas diffusion layer of a cathode have uniform area density of about 115 g/m². The area density represents sum of an aerial densities of a backing layer and a micro-porous layer.

The MEA of the comparative exemplary embodiment have the same configuration of the MEA of the exemplary embodiment except the gas diffusion layer of the cathode. The power density experiment is performed while supplying a dry oxidizing agent to the cathode. Referring to FIG. 12, the power density of the MEA of the exemplary embodiment is about 1.58 times higher than that of the comparative exemplary embodiment.

The area density variation of the gas diffusion layers 315 and 317 can be configured by controlling the area density of backing layers 151 and 171 or controlling the area density of micro-porous layers 152 and 172, or by controlling the area density of the backing layers 151 and 171 and the area density of the micro-porous layers 152 and 172 together. The fuel cell stack according to the fourth exemplary embodiment controls the area density by further subdividing the gas diffusion layers 315 and 317, and accordingly moisture dispersion over the entire areas of an MEA 10 can be more effectively uniform.

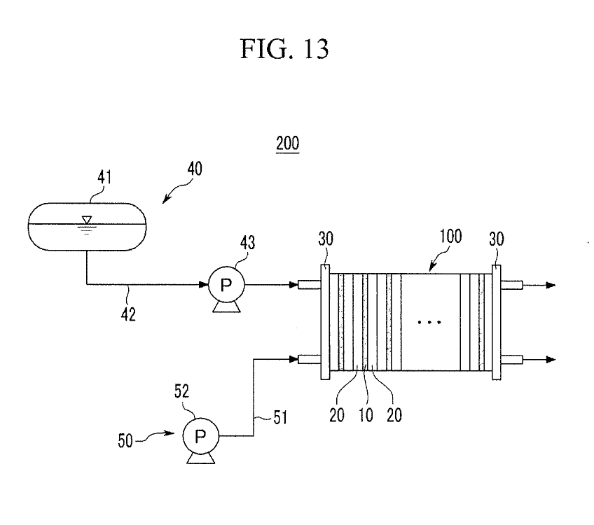

FIG. 13 shows a schematic diagram of the entire configuration of a fuel cell system according to an exemplary embodiment of the present invention. The fuel cell system according to the present exemplary embodiment includes a fuel cell stack of at least one of the first to fourth exemplary embodiments.

Referring to FIG. 13, a fuel cell system 200 includes a fuel cell stack 100, a fuel supply 40 supplying a fuel to the fuel cell stack 100, and an oxidizing agent supply 50 supplying an oxidizing agent to the fuel cell stack 100.

The fuel is a hydrocarbon-based fuel existing in a liquid or gas state such as methanol, ethanol, liquefied natural gas, gasoline, and butane gas, and the oxidizing agent is external air or oxygen gas.

The fuel supply 40 includes a fuel tank 41 storing the liquid or gas fuel, a fuel supply pipe 42 connecting the fuel tank 41 and the fuel cell stack 100, and a fuel pump 43 connected with the fuel tank 41. The fuel pump 43 emits the fuel stored in the fuel tank 41 with a pumping force to supply the fuel to the fuel cell stack 100 through the fuel supply pipe 42.

The oxidizing agent supply 50 includes an oxidizing agent supply pipe 51 connected with the fuel cell stack 100 and an oxidizing agent pump 52 installed in the oxidizing agent supply pipe 51. The oxidizing agent pump 52 inhales external air with a pumping force to supply an oxidizing agent to the fuel cell stack 100 through the oxidizing agent supply pipe 51. In this case, a control valve may be installed in the oxidizing agent supply unit 51 to control the supply of the oxidizing agent.

The fuel cell system 200 is a direct oxidation type that generates electrical energy directly using electrochemical reaction of the fuel and the oxidizing agent. However, the fuel cell system 200 of the present exemplary embodiment is not limited to the direct oxidation type. That is, the fuel cell system 200 may be a polymer electrode membrane type that generates electrical energy using electrochemical reaction of hydrogen or a hydrogen-rich gas and a gas.

A fuel supply of the polymer electrode membrane type of fuel cell system further includes a reformer that generates hydrogen or a hydrogen-rich gas by reforming a fuel.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fuel cell stack comprising:
a plurality of membrane electrode assemblies, each of the membrane electrode assemblies comprising:
an electrolyte membrane;
an anode on a first side of the electrolyte membrane; and
a cathode on a second side of the electrolyte membrane opposite to the first side, wherein the anode and the cathode each comprise a gas diffusion layer, divided into at least two areas such that a first area and a second area of the at least two areas have different area densities; and
a separator between adjacent ones of the membrane electrode assemblies.

2. The fuel cell stack of claim 1, wherein the gas diffusion layer comprises a backing layer and a micro-porous layer.

3. The fuel cell stack of claim 2, wherein the backing layer comprises a thin porous material.

4. The fuel cell stack of claim 2, wherein the backing layer comprises carbon paper, carbon cloth, carbon felt, metal or metal matt.

5. The fuel cell stack of claim 2, wherein the backing layer comprises at least two thin porous plates layered together.

6. The fuel cell stack of claim 2, wherein the micro-porous layer comprises carbon powder, carbon nano-rods, carbon nanowires, carbon nanotubes, a conductive metal, an inorganic material or a ceramic powder.

7. The fuel cell stack of claim 2, wherein the backing layer in the first area has an area density between about 50 g/m² and about 300 g/m² and the backing layer in the second area has an area density between about 10 g/m² and about 50 g/m².

8. The fuel cell stack of claim 2, wherein the micro-porous layer in the first area has an area density between about 30 g/m² and about 100 g/m² and the backing layer in the second area has an area density of about or less than 70 g/m².

9. The fuel cell stack of claim 1, wherein the gas diffusion layer is coated with a hydrophobic material or a hydrophilic material.

10. The fuel cell stack of claim 1, wherein the gas diffusion layer is coated with polytetrafluoroethylene or a sulfonated tetrafluoroethylene copolymer.

11. The fuel cell stack of claim 1, wherein the first area is a different size than the second area.

12. The fuel cell stack of claim 1, wherein the separator has an oxidizing agent inlet and an oxidizing agent outlet, wherein the first area is proximate to the oxidizing agent inlet and has a higher area density than the second area.

13. The fuel cell stack of claim 1, wherein the separator has a fuel inlet and a fuel outlet, wherein the first area is proximate to the fuel inlet and has a higher area density than the second area.

14. A fuel cell stack comprising:
a plurality of membrane electrode assemblies, each of the membrane electrode assemblies comprising:
an electrolyte membrane;
an anode on a first side of the electrolyte membrane; and
a cathode on a second side of the electrolyte membrane opposite to the first side, wherein the anode and the cathode each comprise a gas diffusion layer, wherein an area density of the gas diffusion layer gradually changes over the gas diffusion layer;
a separator between adjacent ones of the membrane electrode assemblies.

15. The fuel cell stack of claim 14, wherein the separator has an oxidizing agent inlet and an oxidizing agent outlet and wherein the area density of the gas diffusion layer of the cathode gradually decreases in a general direction from the oxidizing agent inlet to the oxidizing agent outlet.

16. The fuel cell stack of claim 14, wherein the separator has a fuel inlet and a fuel outlet and wherein the area density of the gas diffusion layer of the anode gradually decreases in a general direction from the fuel inlet to the fuel outlet.
